(19) United States
(12) Patent Application Publication
(10) Pub. No.: US 2009/0053988 A1
(43) Pub. Date: Feb. 26, 2009

(54) Method and Device for Extraction of Bones From Fish

(76) Inventor: Kari Koljonen, Uppsala (SE)

Correspondence Address: HARNESS, DICKEY & PIERCE, P.L.C., P.O. BOX 8910, RESTON, VA, 20195, US

(21) Appl. No.: 11/887,943

(22) PCT Filed: Apr. 6, 2006
(86) PCT No.: PCT/SE2006/000415

§ 371 Date: Oct. 5, 2007

(30) Foreign Application Priority Data
Apr. 7, 2005 (SE) 0500791-9

(51) Int. Cl. A22C 25/16

(52) U.S. Cl. 452/135

(57) ABSTRACT

For removing bones (2) from fish fillets (3) a number of rod-like and moveably supported gripping means (4) are employed, which are moveably acted on for forcibly clamping fish bones (2) between gripping surfaces (19) thereof. The gripping means are actuatably controlled for permitting that bones having been introduced there between are clamped between gripping surfaces (19) of adjacent gripping means, to thereby provide the desired clamping force between the gripping means (4).

### TECHNICAL FIELD

The present invention relates generally to devices for removing bones from fish fillets, and more specifically relates to a picking head and to such a device, respectively, which have mutually cooperating gripping means that are intended for forcibly clamping fish bones there between, as well as to a method of extracting bones from fish.

### BACKGROUND

Through EP 0 567 515 B1 and U.S. Pat. No. 6,193,594 B1 devices are known, which are intended for extraction of fish bones. For gripping means these known devices are provided with a rotating drum or flaps that catch the fish bones by cooperating with a counterstay. Even though the clamping force may be controlled the gripping ability will be heavily reduced due to the fact that the counterstay lacks driving function. The friction that occurs between bone and counterstay during the extraction process may contribute to the bone breaking, and furthermore bones that are situated below the surface of the meat cannot be removed with the known devices without surrounding meat being removed with the gripping means. Such waste becomes far too costly for the producers.

### SUMMARY

The invention effectively eliminates the above discussed disadvantages and shortcomings of the known devices.

A general object of the invention is to provide an improved device as well as an improved method for removing fish bones, which, when it comes to quality, allow for a very effective removal of fish bones from fish fillets of different kinds.

In summary, this object is achieved by using simple means for making it possible to effectively remove the fish bones, without surrounding meat around the bones being removed with them. In particular, this is achieved by means of a picking head having gripping means that are provided side by side and that are suspended in such a way therein that they are moveable relative to each other in a guided or controlled manner. Hereby, the gripping means may be inserted into a fish fillet and by the controlled, relative mobility they will permit that fish bones in the fillet are first introduced between adjacent gripping means and are then gripped thereby.

In a practical design the gripping means of the picking head are moveably connected to moveable spacer plates in displaceable side members of a body or frame. The side members are acted on in a controlled forcible manner by means of moveable thrust shafts, whereby the clamping force of the gripping means may be controlled by means of a jacket or shell surrounding the body.

The described and further objects of the invention are met by the invention as defined in the appended patent claims. Further preferred embodiments of the invention are specified in the dependent subclaims.

### BRIEF DESCRIPTION OF THE DRAWINGS

The invention, together with further objects and advantages thereof, are clarified with reference to the following description taken together with the accompanying drawings, in which:

FIG. 1 illustrates a side view of a picking head according to one embodiment of the invention, in a bone clamping position;

FIG. 2 illustrates the picking head according to FIG. 1, from below;

FIG. 3 illustrates a front view of the picking head of FIG. 1;

FIG. 4 illustrates the picking head of FIG. 1, from above;

FIG. 5A illustrates a side view of the picking head of FIG. 1 mounted on a chain;

FIG. 5B illustrates a side view of the picking head of FIG. 1 mounted on a wheel; and

FIG. 6 illustrates rod-like gripping means.

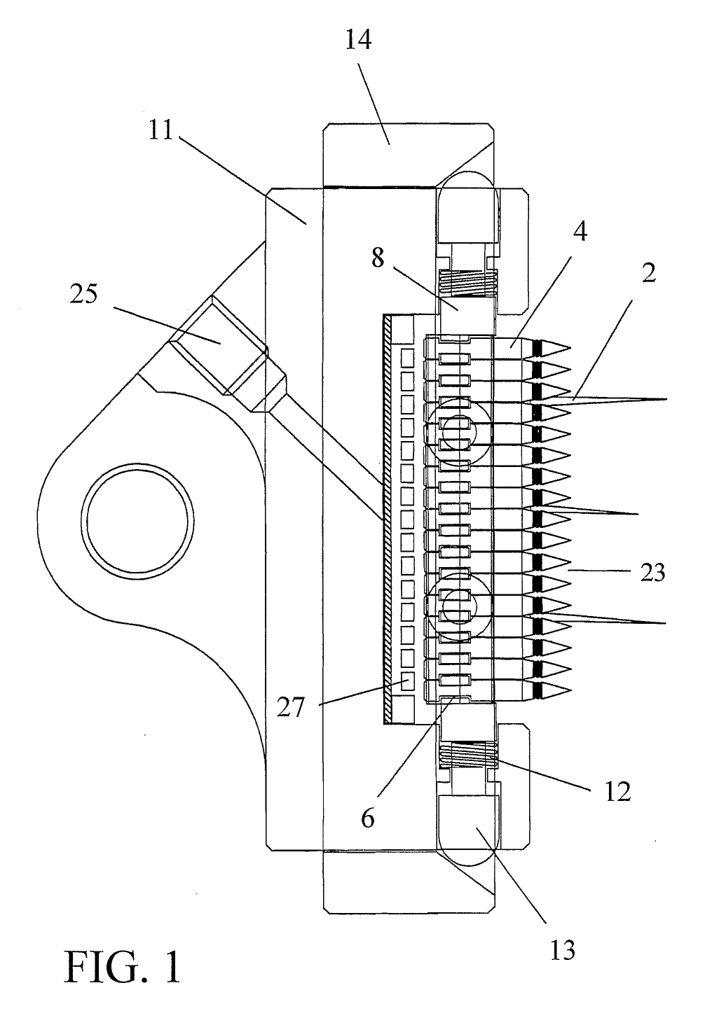

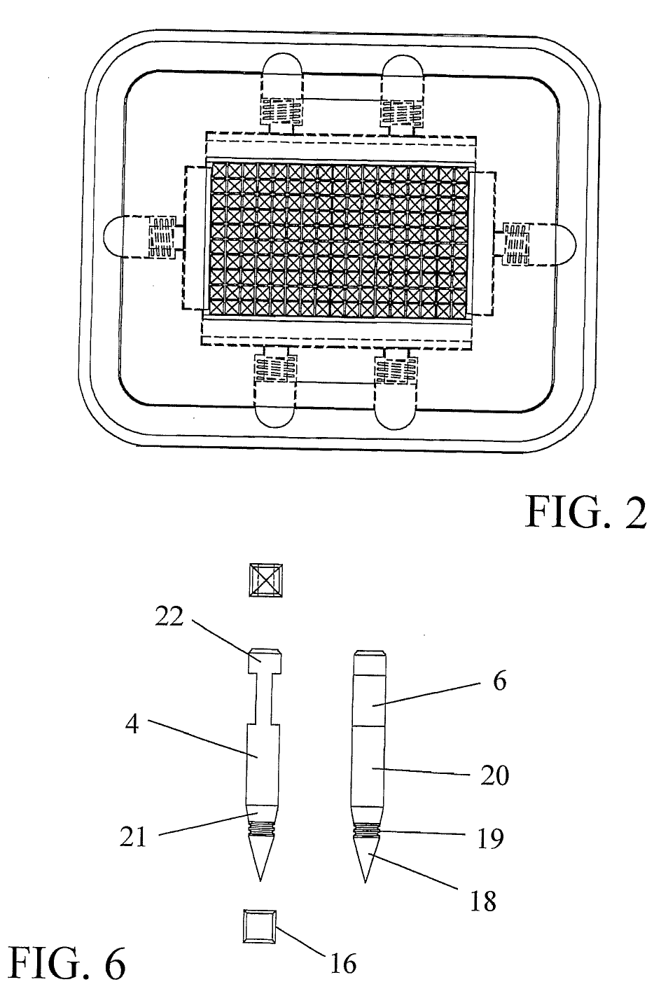

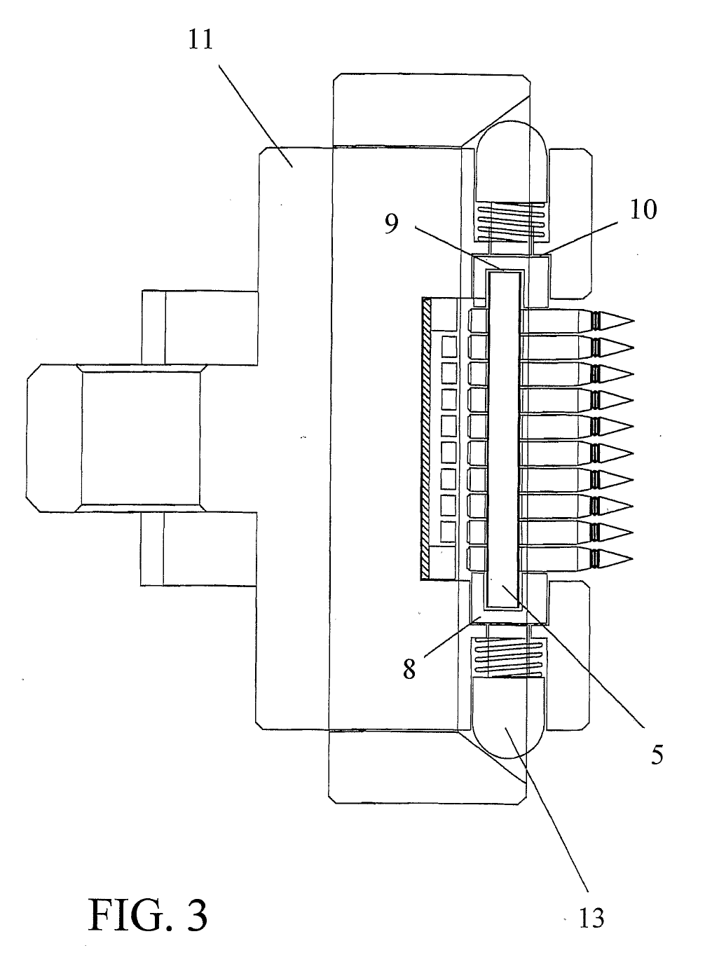

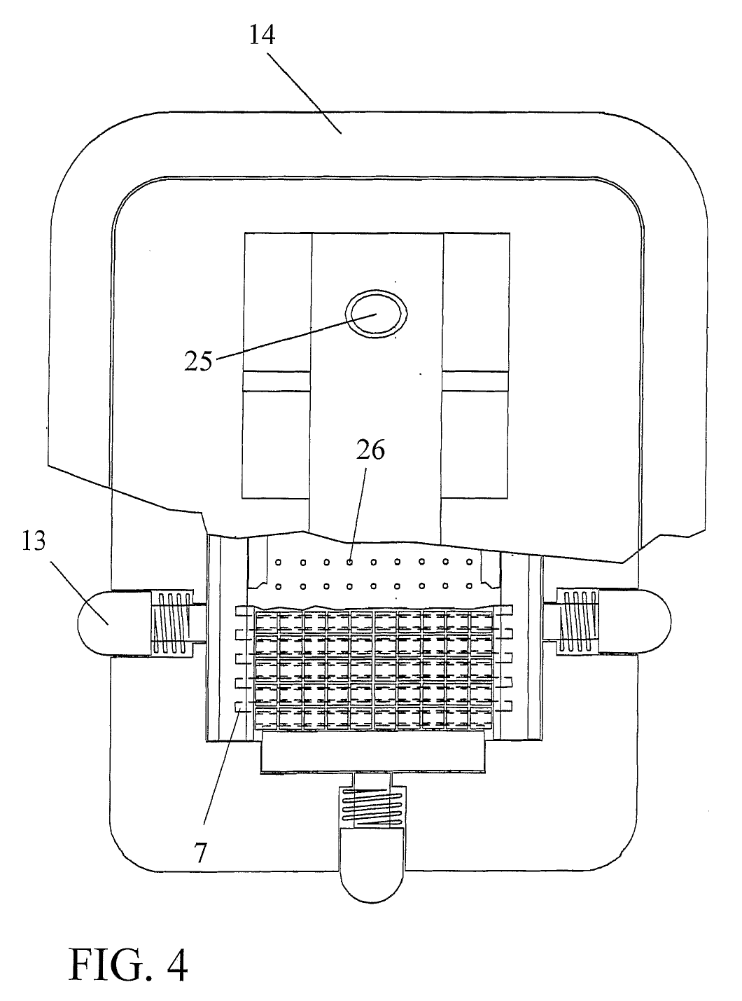

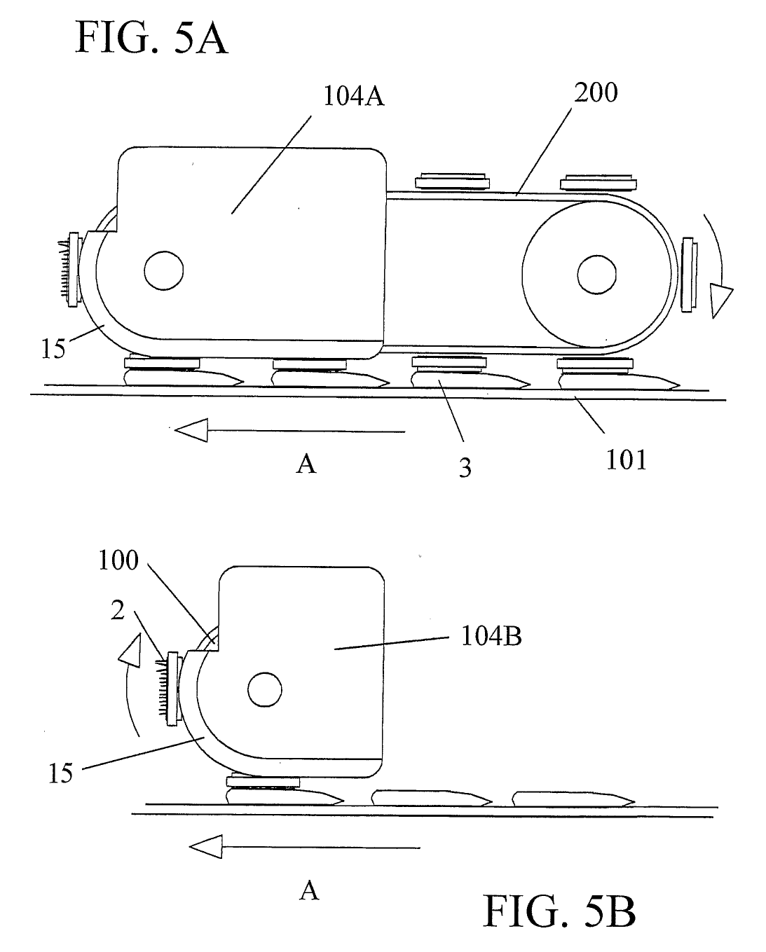

Exemplifying embodiments of the invention are illustrated in FIGS. 1-6. In the illustrated embodiment a device 104A and 104B, respectively, (see FIGS. 5A and 5B, respectively) for removing bones 2 from fish 3, primarily fish fillets, contains a picking head 1 that consists of a body 11 in which a number of gripping means 4 are suspended in a formation provided side by side.

As is illustrated most clearly in FIG. 6 the actual gripping means 4 are rod-like and have a general square profile 16. At a lower end thereof, the gripping means 4 are furthermore provided with a point 18 above which is provided a gripping surface 19 having parallel gripping grooves. Above the surface 19 being provided with gripping grooves, the gripping means 4 has a thicker portion 20 extending from a phase or chamfer 21 closest to the gripping surface 19 and to the head end 22 of the gripping means 4, in order to provide a predetermined gap 23 between the surfaces 19 having gripping grooves, in a later described bone clamping position. The upper portion 20 has essentially flat side surfaces so that the gripping means 4 partially contact each other in this bone clamping position.

The gripping means 4 are suspended in such a manner in the body 11 that they are freely, but restrictedly moveable relative to each other. In particular, the gripping means 4 are moveably suspended between spacer plates 5, the ends 7 of which are loosely inserted into recesses 9 that are formed in side members 8, which are in turn slideably supported in grooves 10 formed in the body 11. The spacer plates 5 are received with loose fit in slots 6 formed in two opposite side surfaces of each gripping means 4, in the thicker portion 20 just below the head end 22. The spacer plates 5 run in the slots 6 of two adjacent rows of gripping means 4, and thus have a thickness being slightly smaller than the combined depth of two adjacent slots 6, so that they extend partially through the gripping means 4. The slots 6 in the gripping means 4 are also somewhat higher, compared to the spacer plates 5, which means that the gripping means 4 may rock unhindered in all directions to find their way past harder portions such as bones 2 when the picking head 1 with the gripping means 4 in an insertion position is pressed down into the fish 3 (see FIGS. 5A and 5B). This suspension of the gripping means 4 results in that in the insertion position bones 2 of a fish 3 may be introduced there between and that the gripping means 4 in a subsequent bone clamping position may be actuated in a controlled manner to partially contact each other, to permit that bones having been introduced there between are clamped between the gripping surfaces 19 of adjacent gripping means 4.

In order to be able to grip bones 2 in fish fillets 3 the set of adjacently provided gripping means 4 are maneuverable in a controlled or guided manner through the moveable side members 8 and spring loaded 12 thrust shafts 13 that in a bone clamping phase are acted on by a chamfered surface of a jacket 14 being moveably supported by the body. In the clamping position the moveably supported jacket 14 engages a pressure rail 15 of the device 104A, 104B, being formed as a cam surface and being fixed in relation to the moveable picking head to provide the desired clamping force between the gripping means 4. Specifically, the controlled displacement of the jacket 14 in a downward direction in FIG. 1 results in that the spring-loaded thrust shafts 13 act on the gripping means 4, through the side members 8, so that in the bone clamping position these mutually contact one another at their upper portions 20 to forcibly clamp fish bones 2 that have been introduced between these gripping surfaces 19 when the picking head 1 is pressed down into the fish 3. When so required and in order to create more space between the gripping means 4, the spacer plates 5 are also moveable sideways in the grooves 9 of the side members 8.

It shall be briefly mentioned, with reference to FIGS. 5A and 5B, that in a device 104A, 104B several picking heads 1 according to the invention may be mounted on a chain 200 or a wheel 100 to be carried forward in the direction of the arrow A and to be pressed, in the insertion position, against fish fillets 3 that are conveyed in under the gripping means 4 by means of a conveyor 101. The pressure rail 1 pushes down the jacket 14 after which the thrust shafts 13 act on the side members 8 to press together the gripping means 4 in the bone clamping position. The conveyor 101 and the picking heads 1 do, at least in the bone clamping position, move with the same speed in the direction of the arrow A. In the embodiment according to FIG. 5B the picking heads 1 follow the peripheral surface of the wheel 100 whereas the fillets 3 proceed in the direction of the arrow A, whereupon the bones 2 are extracted from the fillet 3. The pressure springs 12 reset the thrust shafts 13, after which the gripping means 4 return to the free or neutral position.

With reference to the above given description it should be clear that the invention comprises a method for gripping and removing bones 2 from fish 3 that are conveyed in under a number of mutually moveable gripping means 4 by a conveyor 101. A set of the gripping means 4 are supported with restricted free mobility adjacent each other in a picking head 1 and in the condition of the gripping means 4 wherein they are restrictedly freely moveable they are brought into engagement with a fish 3 being conveyed on the conveyor belt 101.

With the gripping means 4 engaging the fish 3, they are acted on in a guided and controlled manner, to assume a fixed bone clamping position in which they contact the adjacent gripping means and in which gripping means, in the relevant case, between them clamp bones 2 that have been introduced there between. Then, the gripping means 4 are withdrawn in a direction away from the fish 3 that is conveyed on the conveyor belt 101, whereby the bones 2 that are clamped between the gripping means 4 are extracted from the fish 3.

In one embodiment of the method several picking heads 1 are supported distributed one after the other around the circumference of a wheel 100 and the wheel 100 is driven at such a speed that its peripheral speed and thus the speed of the picking heads 1 at least in the bone clamping position corresponds to the speed of the conveyor belt 101.

In an alternative embodiment of the method several picking heads 1 are supported distributed one after the other around the circumference of a chain 200 that is driven at such a speed that its speed and thus the speed of the picking heads 1 at least in the bone clamping position corresponds to the speed of the conveyor belt 101.

In both embodiments of the method the conveyor belt 101 and fish conveyed thereon move essentially horizontally and the gripping means 4 that are supported in the respective picking head 1 are moved from above, into engagement with the respective fish 3, with the gripping means 4 directed essentially vertically.

Cleaning takes place in a closed space by the fact that water or other detergent under pressure is lead in through an opening 25 in the body 10 and is conducted out, and distributed between the gripping means 4, through apertures 26 in a screen 27. Hereby, is achieved a continuous cleaning of the picking heads 1 during operation.

The invention is not restricted to the embodiments that have been described above and that have been illustrated in the drawings, but may be varied within the scope of the patent claims, without deviating from the basic idea of the invention.

1. A picking head for forcibly clamping and removing bones from fish by means of a number of mutually moveable gripping means, wherein a set of gripping means that are provided adjacent each other, in that the gripping means are supported for restricted free mobility in a body of the picking head in order to permit the introduction of bones of a fish there between in an insertion position and in that the gripping means in a bone clamping position, in a controlled manner are actuatable into partial contact with one another to permit that bones having been introduced there between are clamped between gripping surfaces of adjacent gripping means.

2. A picking head according to claim 1, wherein the gripping means are moveably suspended between spacer plates that are received with loose fit in slots formed in two opposite side surfaces of each gripping means, in that the ends of the spacer plates are loosely inserted into recesses in side members that are slideably supported in grooves in the body, in that for providing a desired clamping force between the gripping means in the bone clamping position, the gripping means are maneuverable in a controlled manner, to partially contact each other, by means of the moveable side members and spring loaded thrust shafts that in the bone clamping position are acted on by a moveable jacket in the picking head, by its contact with a fixed cam surface.

3. A picking head according to claim 1, wherein the gripping means are rod-like, have a square profile and are provided with a point above which is provided a gripping surface, in that the gripping means have a thicker portion extending from a chamfer adjacent the gripping surface and to a head-end of the gripping means, in order to form a predetermined gap between the gripping surfaces in the bone clamping position.

4. A picking head according to claim 1, wherein an opening in the body for passing in liquid under pressure therein and by a screen having apertures for directing the liquid out for distribution between the gripping means and for continuous cleaning of the picking head during operation.

5. A device for forcibly clamping and removing bones from fish that are conveyed in under a number of mutually moveable gripping means by a conveyor wherein a number of picking heads mounted on a wheel or alternatively on a chain, in that the picking heads are each provided with a set of gripping means that are provided adjacent each other, whereby the gripping means are supported for restricted free movement in a body of the picking head to permit the introduction of bones of a fish there between in an insertion position and in that in a bone clamping position the gripping means are actuatable in a controlled manner to partially contact each other, to permit that bones having been introduced there between are clamped between gripping surfaces of adjacent gripping means.

6. A device according to claim 5, wherein the conveyor and the picking heads at least in the bone clamping position are moveable with the same speed in the same direction, by a fixed cam surface that in the bone clamping position engages a moveable jacket in the picking head, to maneuver the gripping means, in a controlled manner and through side members being moveable in the body and spring loaded thrust shafts, to partially contact one another.

7. A method for gripping and removing bones in fish that are conveyed in under a number of mutually moveable gripping means by a conveyor, wherein:
a set of the gripping means are supported for restricted free movement adjacent one another in a picking head;
in the restrictedly freely moveable condition of the gripping means these are brought into engagement with a fish being conveyed on the conveyor belt;
with the gripping means engaging the fish they are actuated, in a controlled manner, to a fixed bone clamping position in which they contact adjacent gripping means and in which the gripping means between them clamp bones that have been introduced there between; and
the gripping means are then moved in a direction away from the fish being conveyed on the conveyor belt, whereby the bones being clamped between the gripping means are pulled out from the fish.

8. A method according to claim 7, wherein several picking heads are supported, distributed one after the other around the circumference of a wheel being driven with such speed that its peripheral speed and thus the speed of the picking heads at least in the bone clamping position corresponds to the speed of the conveyor belt.

9. A method according to claim 7, wherein several picking heads are supported, distributed one after the other around the circumference of a chain being driven with such speed that its speed and thus the speed of the picking heads at least in the bone clamping position corresponds to the speed of the conveyor belt.

10. A method according to claim 7, wherein the conveyor belt and fish being conveyed thereon are moved essentially horizontally and in that the gripping means being supported in the respective picking head, from above are moved into engagement with the respective fish, with the gripping means directed essentially vertical.
